(19) United States
(12) Patent Application Publication
(10) Pub. No.: US 2001/0012030 A1
(43) Pub. Date: Aug. 9, 2001

(54) Maintenance mechanism for an ink jet head

(76) Inventor: Masaru Midorikawa, Chiba-shi (JP)

Correspondence Address: ADAMS & WILKS, 50 Broadway, 31st Floor, New York, NY, 10004, US

(21) Appl. No.: 09/760,042

(22) Filed: Jan. 12, 2001

(30) Foreign Application Priority Data
Jan. 19, 2000 (JP) 2000-009819
Dec. 28, 2000 (JP) 2000-400163

(51) Int. Cl. B41J 2/165

(52) U.S. Cl. 347/33; 347/36

(57) ABSTRACT

A maintenance mechanism for an ink jet head is provided, which is free from a problem in that remaining ink adhered to a side surface lower end of an ink jet head is adhered to a paper surface during subsequent printing to stain a printed material. The maintenance mechanism for an ink jet head is provided with ink collecting means (22) that is disposed in a side surface of a wiping device (2) for an ink jet head (1) and in the sweeping area of the ink jet head. The main part of the ink collecting means (22) is composed of an ink collecting roller case (26), a shaft (24a) having ends which are respectively supported rotatably by left and right side walls (26a, 26b) of the ink collecting roller case (26), and a pair of ink collecting rollers (24, 24) that are axially supported on the shaft (24a) in the vicinity of the left and right ends thereof. The pair of the ink collecting rollers (24, 24) are arranged such that the insides thereof are partially pressed against the end portions of the ink jet head (1). Each of the ink collecting rollers (24, 24) is formed of a porous elastic member such as felt, sponge, laminated blotting paper, or a known absorbent polymer material.

### BACKGROUND OF THE INVENTION

1. Field of the Invention

The present invention relates to a maintenance mechanism for an ink jet head, which is used in an ink jet printer.

2. Description of the Related Art

A conventional wiping device is known which includes a wiper blade made of an elastic member such as acrylonitrile-butadiene rubber (hereafter, abbreviated as NBR) and a fluorine rubber, and a wiper blade holder partially clamping both side surfaces of the wiper blade. The wiping device operates such that the wiper blade and an ink jet head are relatively moved while the free end of the wiper blade is pressed against an ink ejection surface of the ink jet head, thereby cleaning the ink ejection surface.

One of the systems of the wiping device for an ink jet head is shown in FIG. 5 and FIGS. 6A to 6C, which are a perspective view and side sectional views, respectively. As shown in FIG. 5 and FIGS. 6A to 6C, the wiping device 2 for an ink jet head 1, of this system, includes a wiper blade unit 8 consisting of a wiper blade 4 that extends in the widthwise direction (in the arrow gll direction in the drawing) of the ink jet head 1 and of a wiper blade holder 6 that clamps the wiper blade 4, and moving means 10 for reciprocatingly moving the wiper blade unit 8 in the direction (in the arrow “h” direction in FIG. 5, and in the arrow “j” direction in FIGS. 6A to 6C) perpendicular to the running direction of the ink jet head 1.

The moving means 10 includes a pair of right and left wiper conveying belts 12 and 12 having upper surfaces to which the wiper blade unit 8 is fixed, drive pulleys 14 and 14 and driven pulleys 16 and 16, on which the right and left wiper conveying belts are suspended, and a gear train 20 provided between a rotational shaft for the drive pulleys 14 and 14 and a rotational shaft of a wiper driving motor 18. The free end of the wiper blade 4 is positioned at a height that allows the free end to be pressed against the ink ejection surface 1ns of the ink jet head 1. Here, the head 1 is made to run in the widthwise direction of the ink jet head, i.e. in the arrow “j” direction in FIG. 6 by a head conveying belt 1c while being guided by the guide shafts 1a and 1b that pierce respectively a pair of guide holes 1ha and 1hb perforated through the lower portion of the head 1 in parallel to each other.

In the system thus constructed, the ink jet head 1 is positioned just above the wiping device 2, and the wiper blade unit 8 is made to run in the longitudinal direction (in the arrow “h” direction in FIG. 5,) of the ink jet head 1, thereby cleaning the ink ejection surface 1ns.

Reference symbols A to F in FIG. 5 denote caps. After the wiping action for the ink jet head 1 is completed, the caps A to F are lifted vertically so that the upper ends thereof abut against the ink ejection surface 1ns of the ink jet head 1 as indicated by the arrow “h” in FIG. 5. This allows the ink ejection surface ins to be kept in a wet state, or to be sealed from the exterior for a vacuum suction when an ink is initially charged into or forcibly ejected from the ink jet head 1.

In the wiping system for an ink jet head as above, when the wiper blade 4 breaks contact with the ink ejection surface 1ns of the ink jet head 1, ink 21 remains on the side surface lower end of the ink jet head 1 as shown in FIG. 6C. If the remaining ink is left ignored, it may be adhered to a paper surface during subsequent printing to stain a printed material.

### SUMMARY OF THE INVENTION

The present invention has been made to solve the above problem inherent in prior art, and an object of the present invention is therefore to provide maintenance mechanism for an ink jet head which does not allow remaining ink adhered to a side surface lower end of the ink jet head to adhere to a paper surface during subsequent printing to stain a printed material.

According to a first aspect of the present invention to attain the above object, there is provided a maintenance mechanism for an ink jet head provided with a wiping device comprising: a wiper blade made of an elastic member; a wiper blade holder partially holding both side surfaces or one side surface of the wiper blade; and moving means for reciprocatingly moving the wiper blade holder in a longitudinal direction of an ink jet head, in which the wiper blade holder is reciprocatingly moved in the longitudinal direction of the ink jet head under a condition that the wiper blade holder is positioned such that a free end of the wiper blade is pressure-contactable with an ink ejection surface of the ink jet head, to thereby wipe the ink ejection surface, the maintenance mechanism characterized by comprising:

ink collecting means, provided in a sweeping area of the ink jet head so as to be pressed against the ink ejection surface.

According to a second aspect of the present invention, the maintenance mechanism for an ink jet head of the first aspect of the invention is characterized in that the ink collecting means is composed of a porous elastic member.

According to a third aspect of the present invention, the maintenance mechanism for an ink jet head of the second aspect of the invention is characterized in that the ink jet collecting means is in the form of a roller.

According to a fourth aspect of the present invention, the maintenance mechanism for an ink jet head of the third aspect of the invention is characterized by further comprising:

ink squeezing means abutting against the ink collecting means.

According to a fifth aspect of the present invention, the maintenance mechanism for an ink jet head of the fourth aspect of the invention is characterized in that the ink squeezing means is composed of a porous rigid member.

According to a sixth aspect of the present invention, the maintenance mechanism for an ink jet head of the fourth or fifth aspect of the invention is characterized in that the ink squeezing means is in the form of a roller.

According to a seventh aspect of the present invention, the maintenance mechanism for an ink jet head of the fourth or fifth aspect of the invention is characterized in that the ink squeezing means is in the form of a protrusion provided on an inner wall of an ink collecting roller case.

According to an eighth aspect of the present invention, the maintenance mechanism for an ink jet head of the third aspect of the invention is characterized in that the ink collecting means is rotated in association with movement of the ink jet head when the ink jet head is moved in a direction away from a print area, and the ink collecting means is not rotated when the ink jet head is moved in a direction approaching to the print area.

According to the arrangement of the first aspect of the present invention, the ink jet head in which the ink is adhered to the side surface lower end portion thereof due to the aforementioned conventional ink jet head wiping system is made to run across the ink collecting means provided in the sweeping area so as to abut against the ink ejection surface, and therefore the adhered ink is collected and removed.

According to the arrangement of the second aspect of the present invention, since the ink collecting means is composed of a porous elastic member, the ink collecting means smoothly abuts against the side surface lower end of the ink jet head, to thereby efficiently collect and remove the adhered ink.

According to the arrangement of the third aspect of the present invention, since the ink collecting means is in the form of a roller made of an elastic member, the adhered ink can be collected and removed further efficiently over the entire width of the ink jet head.

According to the arrangement of the fourth aspect of the present invention, even if the surface layer of the ink collecting means in the form of a roller is saturated with ink, the ink squeezing means is pressed against the ink collecting means in the form of a roller squeezes ink out of the ink collecting means, so that the ink collecting means is returned to the unsaturated state. Therefore, it is possible to continuously and further efficiently collect the adhered ink. Further, since the relative motion between the ink ejection surface and the ink collecting means in the form of a roller is a rotational motion, and thus the sliding effect is reduced, the durability of the ink collecting means in the form of a roller is enhanced.

According to the arrangement of the fifth aspect of the present invention, since the ink squeezing means is composed of a porous rigid member, the ink squeezing means is effectively pressed against the ink collecting means in the form of a roller, and thus it is possible to efficiently collect and squeeze out the ink. Further, one the ink is squeezed out, the squeezed ink never be returned to the ink collecting means in the form of a roller, and accordingly, it is possible to squeeze out the ink with the ink squeezing means and collect and remove the ink with the ink collecting means in the form of a roller efficiently and continuously. In addition, after the ink squeezing means is saturated with the collected ink, the ink squeezed out from the ink collecting means in the form of a roller is allowed to flow down along the surface of the ink squeezing means, and therefore there is no case in which the ink squeezing effect is lost.

According to the arrangement of the sixth aspect of the present invention, since the ink squeezing means is in the form of a roller or is composed of a porous rigid member in the form of a roller, the same effect as the effect obtained in the fourth or fifth aspect of the invention can be further efficiently expected.

According to the arrangement of the seventh aspect of the present invention, since the ink squeezing means is composed of a protrusion provided on the inner wall of the ink collecting roller case, or a porous rigid member in the form of a protrusion provided on the inner wall of the ink collecting roller case, the same effect as the effect obtained in the fourth or fifth aspect of the invention can be further efficiently expected.

According to the arrangement of the eighth aspect of the present invention, the ink bubble is prevented from being generated when the ink collecting roller is rotated while being in contact with the ink jet head. Therefore, it is possible to eliminate the stain of the paper caused when the bubble is popped.

### BRIEF DESCRIPTION OF THE DRAWINGS

In the accompanying drawings:

FIG. 1 is a perspective view showing the entire arrangement of a maintenance mechanism for an ink jet head according to a first embodiment of the present invention;

FIG. 2 is an elevational, sectional view showing the arrangement of the main part of the maintenance mechanism for an ink jet head according to the first embodiment of the present invention;

FIG. 3 is a sectional, side view taken along the line A-A of FIG. 2;

FIG. 4 is a sectional, side view showing the arrangement of the main part of a maintenance mechanism for an ink jet head according to a second embodiment of the present invention;

FIG. 5 is a perspective view illustrating one of systems of a conventional wiping device for an ink jet head;

FIG. 6 is a sectional, side view illustrating one of systems of a conventional wiping device for an ink jet head;

FIG. 7 is a sectional, side view showing the arrangement of the main part of a maintenance mechanism for an ink jet head according to a third embodiment of the present invention;

FIG. 8 is a perspective view showing the arrangement of a roller stopper in the maintenance mechanism for an ink jet head according to the third embodiment of the present invention;

FIGS. 9A and 9B are explanatory views for explaining operation of the maintenance mechanism for an ink jet head according to the third embodiment of the present invention; and

FIG. 10 is a side, sectional view showing the arrangement of the main part of a maintenance mechanism for an ink jet head according to a fourth embodiment of the present invention.

### DETAILED DESCRIPTION OF THE PREFERRED EMBODIMENTS

Preferred embodiments of the present invention will be described with reference to the accompanying drawings.

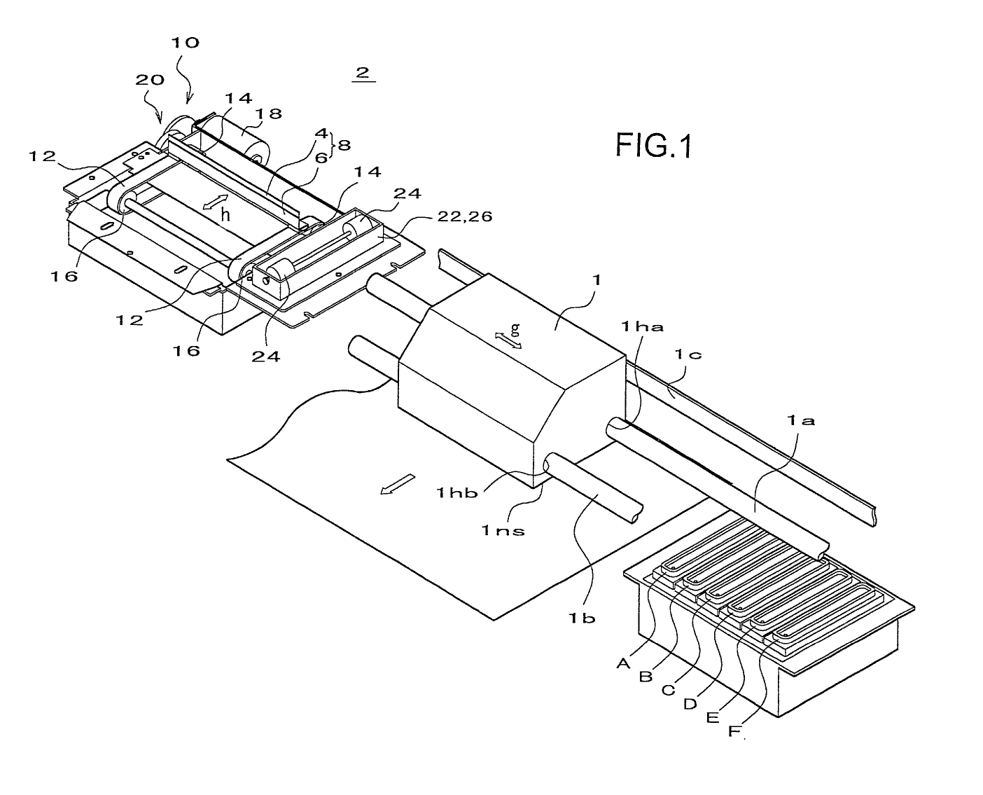

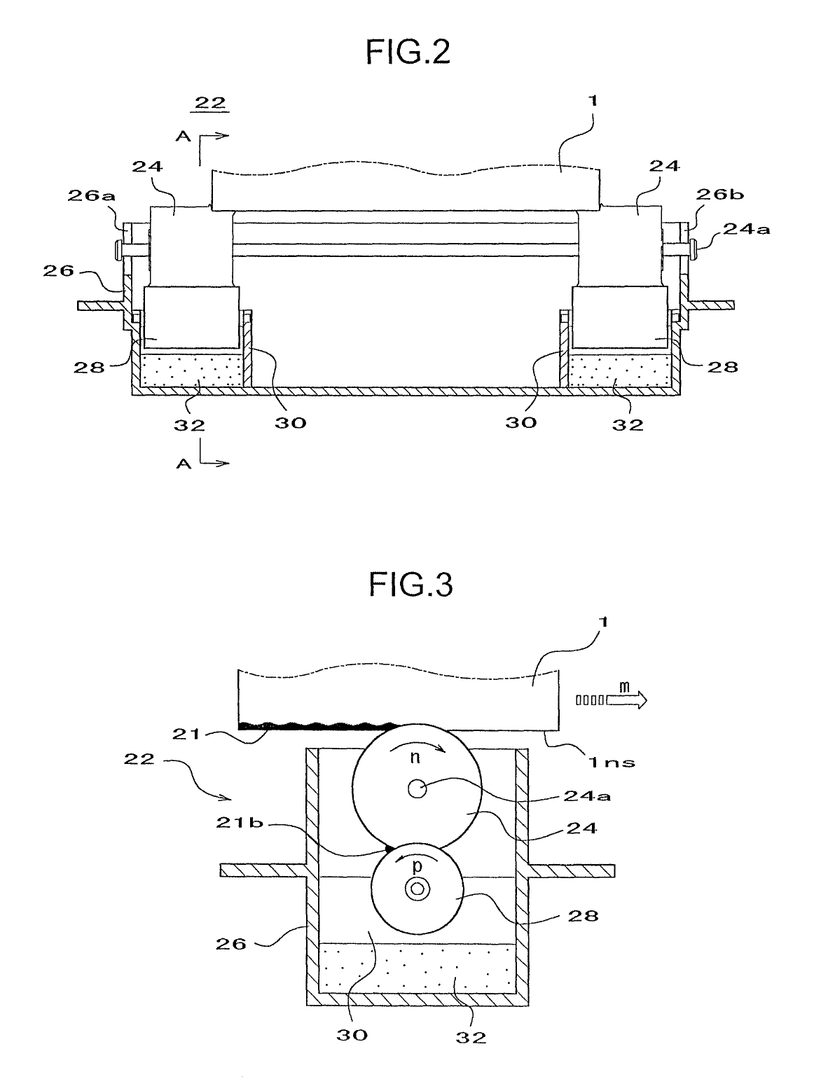

FIG. 1 is a perspective view showing the entire arrangement of a maintenance mechanism for an ink jet head according to a first embodiment of the present invention. FIG. 2 is an elevational, sectional view showing the arrangement of the main part of the maintenance mechanism for an ink jet head according to the first embodiment. FIG. 3 is a sectional, side view taken along the line A-A of FIG. 2.

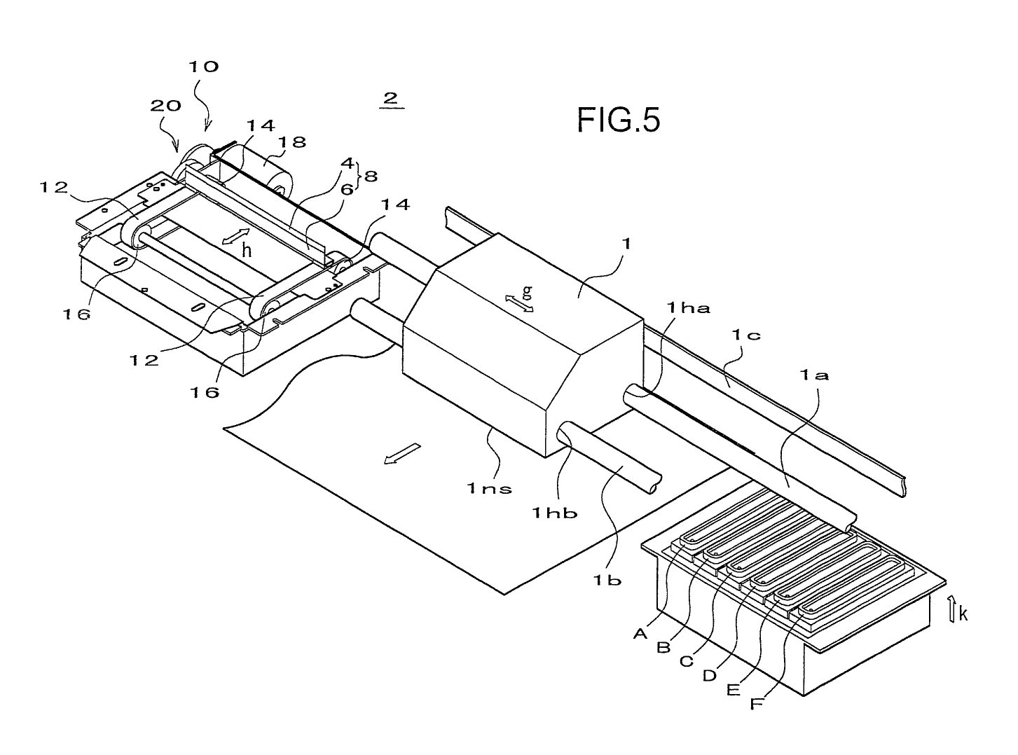

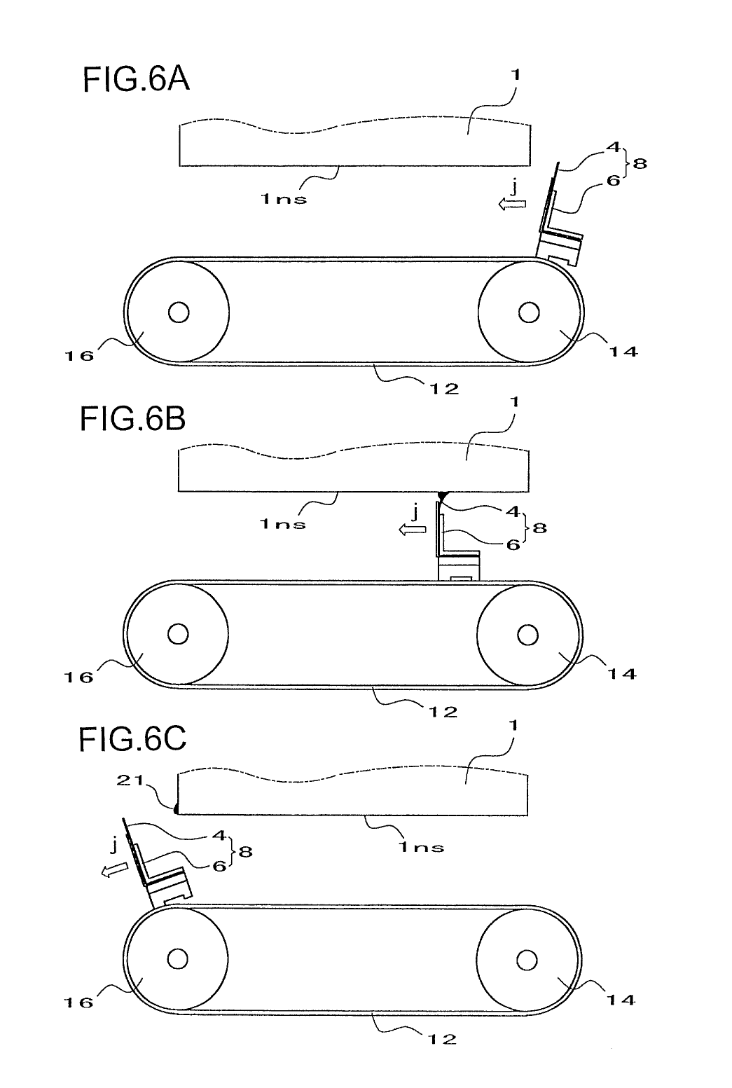

Note that components equivalent to the components of the conventional wiping device for an ink jet head described with reference to FIG. 5 and FIGS. 6A to 6C, are denoted by the same reference numerals as those in FIG. 5 and FIGS. 6A to 6C, and thus the repeated description therefor is omitted here.

The maintenance mechanism for an ink jet head according to the first embodiment of the present invention is provided, as shown in FIG. 1, with ink collecting means 22 that is disposed in a side surface of a wiping device 2 for an ink jet head 1 shown in FIG. 5 and in the sweeping area of the ink jet head.

As shown in FIGS. 1 to 3, the main part of the ink collecting means 22 is composed of an ink collecting roller case 26, a shaft 24a having ends which are respectively supported rotatably by left and right side walls 26a and 26b of the ink collecting roller case 26, and a pair of ink collecting rollers 24 and 24 that are axially supported on the shaft 24a in the vicinity of the left and right ends thereof. The pair of ink collecting rollers 24 and 24 are arranged such that the insides thereof are partially pressed against the end portions of the ink jet head 1.

Each of the ink collecting rollers 24 and 24 is formed of a porous elastic member such as felt, sponge, laminated blotting paper, or a known absorbent polymer material.

Ink squeezing means including an ink squeezing roller 28 is provided below each of the ink collecting rollers 24 and 24. The ink squeezing means is pressed against the ink collecting roller 24 and has substantially the same width as that of the ink collecting roller 24. The ends of the ink squeezing means are axially supported in a rotatable manner by right and left side walls of an ink receiving tank 30 that is provided in the bottom of the right and left end portions of the ink collecting roller case 26. An ink absorbing member 32 is provided in the bottom of the ink receiving tank 30.

Each of the ink squeezing rollers 28 and 28 is formed of a rigid member, for example, a known sintered porous member or foamed porous member.

The ink absorbing member 32 is formed, for example, of urethane foamed material, wetron produced by Kanebou, pulp non-woven fabric, or other materials that can catch ink using a capillary action. The ink absorbing member 32 may not necessarily be provided.

Function and effect of the maintenance mechanism for an ink jet head constructed as above will be described below in accordance with the first embodiment.

A. wiping of an Ink Jet Head 1

The ink jet head 1 is positioned just above the wiping device 2 shown in FIG. 1, and then the wiper blade unit is moved in either one of the directions indicated by arrow “h” in FIG. 1. Consequently, when the wiper blade 4 breaks contact with an ink ejection surface 1ns of the ink jet head 1, ink 21 remains in one or both of right side surface lower end and left side surface lower end of the ink jet head 1 as shown in FIG. 3.

B. Removal of the remaining ink 21 on the side surface lower ends of the ink jet head 1

(1) The ink jet head 1 is made to run in either one of the directions indicated by the arrow “g”, in the direction perpendicular to the paper surface of FIG. 2, and in the arrow “m” direction of FIG. 3, so that the ink jet head 1 passes across the ink collecting means 22. Then, as shown in FIG. 2, the ink collecting rollers 24 and 24 are rotated in the arrow “n” direction in FIG. 3 while the upper end portions of the insides of the ink collecting rollers 24 and 24 made of a porous elastic member are partially pressed against the ink ejection surface 1ns of the ink jet head 1, thereby collecting the remaining ink 21 from the side surface lower ends of the ink jet head 1.

(2) As the ink collecting rollers 24 and 24 are rotated, the ink squeezing rollers, which are made of a porous rigid member and which are pressed against the lower portions of the ink collecting rollers 24 and 24, are rotated in the arrow “p”, direction of FIG. 3. Consequently, the ink, which has been collected within the surface layers of the ink collecting rollers, is squeezed out and transferred to the ink squeezing rollers. Accordingly, the surface layers of each ink collecting roller is returned to an unsaturated state.

(3) When the surface layers of each ink squeezing roller is put into an ink saturated state as a consequence of collecting ink therein, the ink 21b (see FIG. 3) squeezed out and transferred thereto is allowed to flow down along the surface of the ink squeezing roller to be collected in the ink collecting member 32.

Next, a maintenance mechanism for an ink jet head according to a second embodiment of the present invention will be described with reference to the accompanying drawings.

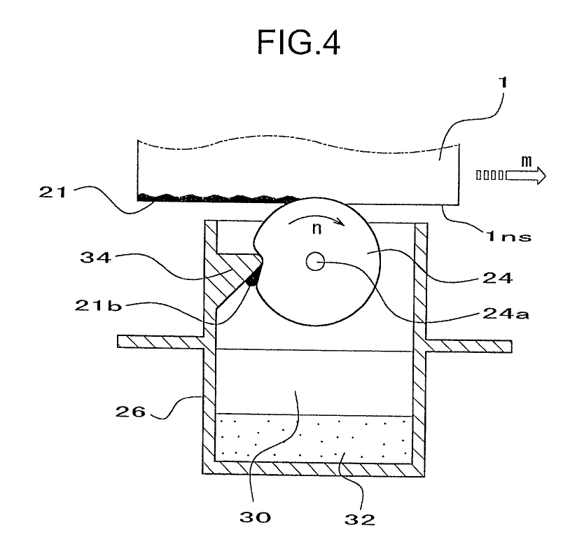

FIG. 4 is a sectional, side view partially showing the maintenance mechanism for an ink jet head according to the second embodiment of the present invention.

This embodiment is the same as the first embodiment described with reference to FIGS. 1 to 3, with the exception of the following points:

That is, the first embodiment employs, as the ink squeezing means, the ink squeezing roller 28 pressed against the ink collecting roller 24, whereas this embodiment employs, in place of the ink squeezing roller 28, an ink squeezing protrusion 34 that is provided on the inner wall of the ink collecting roller case 26 and that is made of a porous rigid member having its tip pressed against the ink collecting roller.

Function of this embodiment thus constructed is substantially the same as the function of the first embodiment, provided that the ink squeezing roller 28 or the ink squeezing rollers 28 in the above discussion be replaced with the ink squeezing protrusion 34 or the ink squeezing protrusions 34, and that the ink squeezing protrusion 34 is simply stationary in contrast to the ink squeezing roller 28 rotated in association with the rotation of the ink collecting roller 24. Accordingly, the repeated discussion for the function is omitted here.

Next, a maintenance mechanism for an ink jet head according to a third embodiment of the present invention will be described.

The first or second embodiment may encounter a case in which an ink bubble is generated when the ink collecting roller 24 breaks contact with the ink jet head 1 after the ink collecting roller is rotated while being in contact with the ink jet head 1, and the ink bubble thus generated is adhered to the ink jet head 1. The ink bubble thus adhered to the ink jet head 1 may stain the paper surface since the ink bubble may be popped when the ink jet head 1 is moved over the print paper. This embodiment is designed to solve this problem.

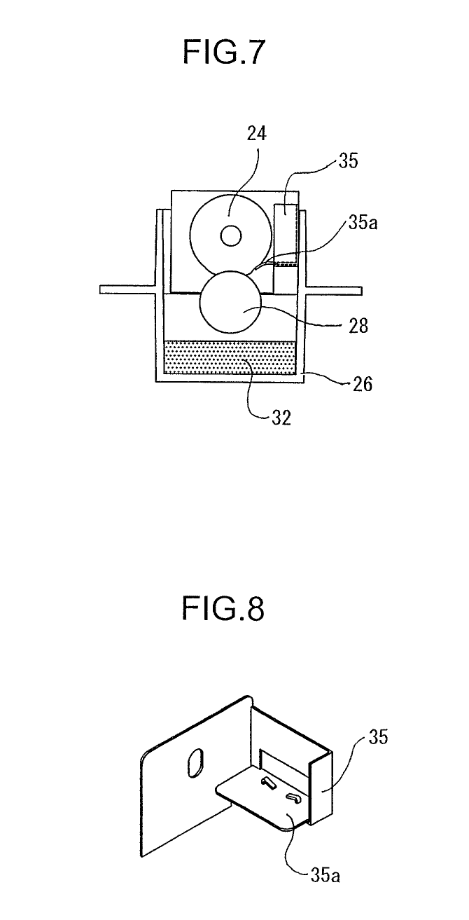

The third embodiment will be described with reference to the drawings. As shown in FIG. 7, this embodiment is designed such that a roller stopper 35 for restricting the rotation of the ink collecting roller 24 is added to the arrangement of the first embodiment. FIG. 8 is a perspective view showing the arrangement of the roller stopper 35. The roller stopper 35 is formed by bending a PET film (with a thickness of 0.125 mm). The material for the roller stopper 35 may be a polyimide film, or an elastic sheet material such as polycarbonate, urethane or the like. The roller stopper 35 may be molded from a plastic material such as polypropylene, polyethylene, or polyacetal. As to the thickness, it can be appropriately selected depending on the characteristics of the ink and the material and hardness of the ink collecting roller 24.

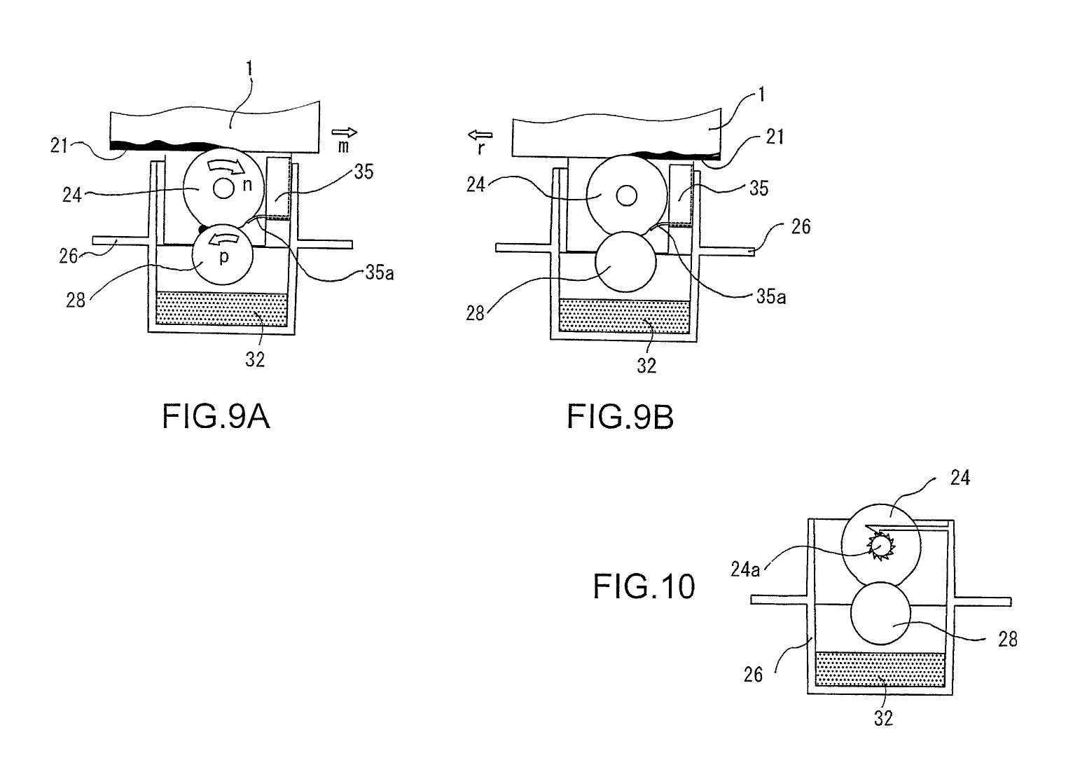

As shown in FIG. 7, the roller stopper 35 is positioned such that a stopper portion 35a thereof bites into the ink collecting roller 24 to be deflected slightly, and is attached to the ink collecting roller case 26 in this state. The amount of the deflection is set appropriately so that the ink collecting roller 24 rotates only in one direction while being in contact with the ink jet head According to the above-described arrangement, as shown in FIG. 9A, when the ink jet head 1 is moved in the direction away from the print area, the ink collecting roller 24 rotates following the ink jet head 1 since the rotational load received by the ink collecting roller 24 from the stopper portion 35a of the roller stopper 35 is small. Therefore, it is possible to efficiently create the unsaturated state and maintain the absorbing force. On the other hand, as shown in FIG. 9B, when the ink jet head 1 is moved in the direction approaching to the print area, the ink collecting roller 24 is not rotated since the stopper portion 35a works against the rotation. Accordingly, no ink bubble is generated, and it is possible to prevent the stain of the paper.

In this embodiment, the PET film is bent to form the roller stopper 35, and the roller stopper 35 is fixed to the ink collecting roller case 26. However, the present invention should not be limited thereto. For example, the stopper portion 35a may be molded integrally with the ink collecting roller case 26. Further, as shown in FIG. 10, the roller stopper may be realized such that a shaft 24a of the ink collecting roller 24 is formed with rachet teeth, and a member serving as a stopper member with respect to the rachet teeth is abutted against the rachet teeth. That is, the completely same effect can be obtained if the roller stopper is arranged such that the ink collecting roller 24 is rotatable in one direction but inhibited to be rotated in the other direction.

A maintenance mechanism for an ink jet head according to the present invention is free from a problem in that remaining ink adhered to a side surface lower end of an ink jet head is adhered to a paper surface during subsequent printing to stain a printed material.

What is claimed is:

1. A maintenance mechanism for an ink jet head comprising:
a wiping device having a wiper blade made of an elastic member, a wiper blade holder partially holding both side surfaces or one side surface of the wiper blade, and moving means for reciprocatingly moving the wiper blade holder in a longitudinal direction of an ink jet head, and ink collecting means, provided in a sweeping area of the ink jet head so as to be pressed against the ink ejection surface for collecting ink adhere to the side surface of the ink jet head.

2. The maintenance mechanism for an ink jet head according to claim 1, wherein the ink collecting means is composed of a porous elastic member.

3. The maintenance mechanism for an ink jet head according to claim 2, wherein the ink jet collecting means is in the form of a roller.

4. The maintenance mechanism for an ink jet head according to claim 3, further comprising:
ink squeezing means abutting against the ink collecting means.

5. The maintenance mechanism for an ink jet head according to claim 4, wherein the ink squeezing means is composed of a porous rigid member.

6. The maintenance mechanism for an ink jet head according to claim 4 or 5, wherein the ink squeezing means is in the form of a roller.

7. The maintenance mechanism for an ink jet head according to claim 4 or 5, wherein the ink squeezing means is in the form of a protrusion provided on an inner wall of an ink collecting roller case.

8. The maintenance mechanism for an ink jet head according to claim 3, wherein the ink collecting means is rotated in association with movement of the ink jet head when the ink jet head is moved in a direction away from a print area, and the ink collecting means is not rotated when the ink jet head is moved in a direction approaching to the print area.
